(19) United States
(12) Patent Application Publication
(10) Pub. No.: US 2001/0050793 A1
(43) Pub. Date: Dec. 13, 2001

(54) Point to point optical link

(76) Inventors: Arnold Peter Roscoe Harpin, Oxford (GB); Timothy Bestwick, Birmingham (GB)

Correspondence Address: FLESHNER & KIM, LLP, P.O. Box 221200, Chantilly, VA, 20153-1200, US

(21) Appl. No.: 09/773,937

(22) Filed: Feb. 2, 2001

(30) Foreign Application Priority Data
Feb. 3, 2000 (GB) 0002513.0

(51) Int. Cl. H04J 14/02; H04B 10/12

(52) U.S. Cl. 359/173; 359/124

(57) ABSTRACT

A point to point optical link from a transmitter (1) to, a receiver (2) via an optical fiber (3), the transmitter (1) comprising light sources (4) providing signals of different wavelengths and a multiplexer (6) combining the signals onto a single channel for transmission along the optical fiber (3), and the receiver (2) comprising light sensors (8) and a demultiplexer (10) for separating the signals of different wavelengths and directing each to a respective light sensor (8). The output of the transmitter (1) is temperature dependent but arranged so that the change in wavelength with respect to temperature for each of the signals is similar, and the demultiplexer (10) being adjustable so that its response to signals with respect to their wavelength can be actively tuned so as to follow variations in the wavelength of the signals received.

### FIELD OF INVENTION

This invention relates to a point to point optical link between a transmitter and a receiver via an optical fibre therebetween.

### BACKGROUND ART

There is a demand for cost-effective means of making high-speed optical communications links. One particular demand is for the development of high-speed fibre-optic data links such as those operating at 10 Gbit/s or 12.5 Gb/s. Even faster links will no doubt be required in the future.

There are a number of different technical approaches that can be used for such communications links including:

The transmission rate of a single signal can be increased but this has a number of attendant difficulties, in particular the circuitry required to convert optical signals to electrical signals at higher speeds becomes increasingly complex and expensive.

A plurality of fibres running in parallel could be used, eg ten fibres each carrying 1 Gbit/s, but this may require more complex and hence expensive devices, and may not allow the use of existing optical fibres that have already been installed

A plurality of signals of different wavelengths each carrying some of the data may also be multiplexed onto a single optical fibre. In such an arrangement the temperature of the transmitter and receiver usually need to be stabilized to maintain stable wavelength operation, i.e. so that the wavelengths of transmission are aligned with the corresponding wavelengths of detection. Such temperature stabilization adds significantly to the cost and complexity of the devices, and so is undesirable. If the transfer function of the demultiplexer could be modified so the curves had a substantially square, top-hat form, such problems would not arise as the top-hat form would, in effect, provide a window of wavelengths within which variations had substantially no effect on the output of the device and which were well separated. However, it is difficult and expensive to form a demultiplexer having a transfer function of this form. The temperature dependence of a light source may be in the order of 0.1 nm/degC and devices may be required to operate within a temperature range of 0 deg C to 70 deg C so the output wavelengths can vary significantly. The transmitter and receiver may also be at different temperatures, which further exacerbates the problem.

The present invention aims to provide a relatively simple and inexpensive point to point link, which avoids these difficulties.

### DISCLOSURE OF INVENTION

According to a first aspect of the invention, there is provided a point to point optical link comprising a transmitter, a receiver and an optical fibre for transmitting signals from the transmitter to the receiver, the transmitter comprising a plurality of light sources for providing signals of different wavelengths and combining means for combining the signals of different wavelengths onto a single channel for transmission along the optical fibre, and the receiver comprising a plurality of light sensors and demultiplexing means for separating the signals of different wavelengths and directing each wavelength to a respective light sensor, the output of the transmitter being temperature dependent and arranged so that the change in wavelength with respect to temperature for each of the signals of different wavelength is substantially similar, and the demultiplexing means being adjustable and arranged so that its response to signals with respect to their wavelength can be actively tuned so as to substantially follow variations in the wavelengths of the signals received.

Preferred and optional features of the invention will be apparent from the following description and from the subsidiary claims of the specification.

### BRIEF DESCRIPTION OF DRAWINGS

The invention will now be further described with reference to the accompanying drawings, in which:

FIG. 1 is a schematic diagram of a point to point link according to the invention;

FIG. 2 is a schematic diagram of one form of demultiplexing means which may be used in the invention; and

FIG. 3 illustrates a typical transfer function for

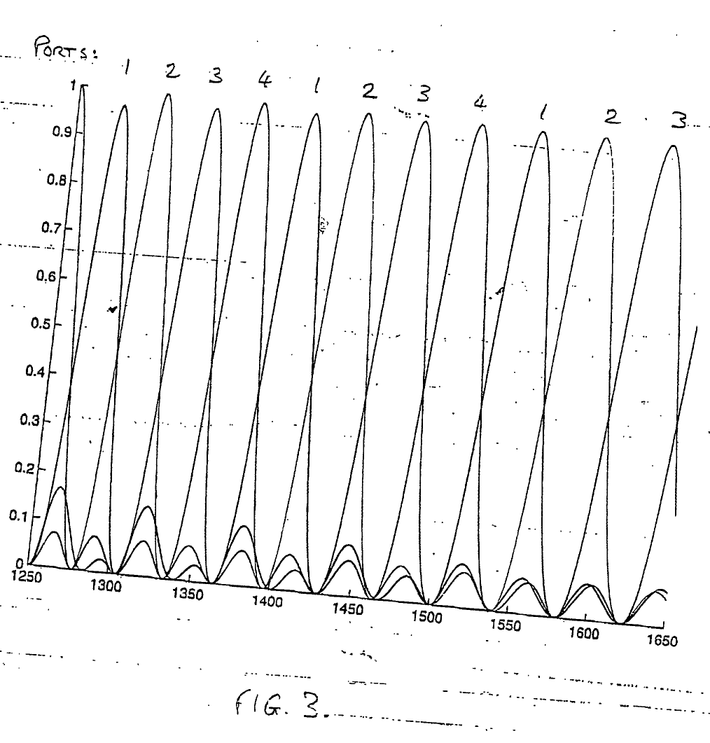

demultiplexing means of the type shown in FIG. 2.

### BEST MODE OF CARRYING OUT THE INVENTION

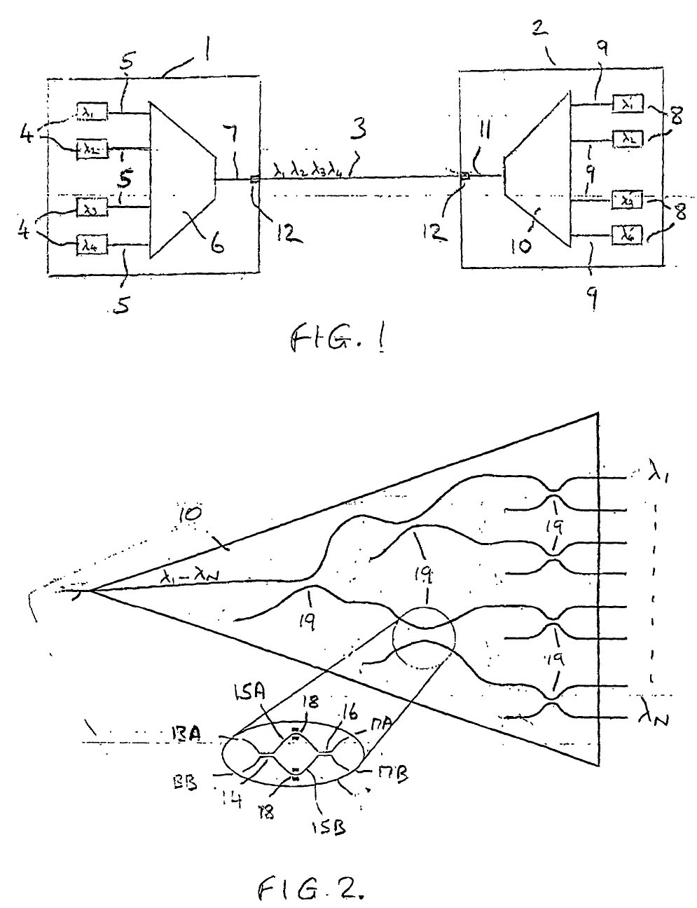

FIG. 1 shows a transmitter 1, a receiver 2 and an optical fibre 3 leading from the transmitter 1 to the receiver 2.

The transmitter 1 comprises a plurality of light sources 4, in this case four, connected by waveguides 5 to signal combining means 6. The light sources 4 may be distributed feedback (DFB) semiconductor lasers, eg InP lasers, and the combining means 6 may comprise a cascade of Mach-Zehnder interferometers which together combine signals received on four inputs onto a single output waveguide 7. It is also possible to use a cascade of Y-junctions instead of the interferometers, although this has the disadvantage of introducing additional optical loss into the circuit.

The four wavelengths used may be spaced apart by 10 nm to 25 nm, eg 1280, 1300, 1320 and 1340 nm. Other wavelengths and spacing may, however, be used, although a spacing of more than 10 nm is generally preferred so that the wavelength spacing is appreciably larger than the expected change in the wavelength due to temperature variations. Wavelengths included in the 1550 nm telecommunications band may also be used. The spacing need not be uniform so long as the wavelengths coincide with peaks in the transfer function of the demultiplexer (as described below).

DFB laser sources have well defined wavelengths (at a known temperature), eg within ±1 nm.

The receiver 2 comprises a plurality of light sensors 8, eg photodiodes, usually one for each of the light sources 4, connected by waveguides 9 to the outputs of a demultiplexer 10. The demultiplexer 10 may comprise a cascade of MachZehnder interferometers which serve to divide the multi-wavelength signal received on input waveguide 11 into separate signals, each of a respective wavelength, on its four outputs.

Both the transmitter 1 and receiver 2 are preferably fabricated on silicon chips, eg silicon-on-insulator chips. For some applications, it also may be advantageous to form the transceiver and receiver on the same chip. The waveguides 5 and 7 and those forming the multiplexer and demultiplexer may be silicon rib (or ridge) waveguides.

The light sources 4 may be mounted on the chip in the manner described in U.S. Pat. No. 5,881,190. The optical fibre 3 may be connected to the waveguides 7, 11 by waveguide connectors 12 as described in U.S. Pat. No. 5,787,214.

The wavelengths of the light sources 4 are temperature dependent and may vary by around 0.1 nm/degC. However, as all the light sources 4 are mounted on the same chip (so are subject to very similar temperature variations), and as they are all emitting fairly similar wavelengths, eg in the 1310 nm window or in the 1550 nm window, their respective outputs will vary in substantially the same manner.

In the example given, the temperature dependence of silicon, in which the optical components are formed, is similar to that of the InP laser diodes. This has the advantage that the movement in the peak wavelength channels of the multiplexer 6 is similar to the movement in the peak wavelength of the lasers 4 with temperature. A similar situation could be achieved with a monolithic approach in which the light sources and the other components are all formed in the same material.

Thus, by an appropriate selection of components, none of which need be complex or expensive to manufacture, it can be arranged that the transmitter 1 transmits a multi-wavelength signal, the individual wavelengths of which are allowed to vary as the temperature of the transmitter varies according to the ambient conditions but which each vary in a substantially similar manner and so vary substantially in unison.

The demultiplexer 10 may comprise a series of Mach-Zehnder interferometers 19 as shown in more detail in FIG. 2. This figure shows a cascade of seven interferometers 19 which together are capable of dividing a multi-wavelength signal comprising eight different wavelengths into eight separate signals each of a respective wavelength. For the four-wavelength example described above, it will be appreciated that a cascade of only three interferometers 19 is required.

The function of such interferometers is well known in the art so will not be described in detail. However, each interferometer 19 comprises two input ports 13A,13B, a first coupler 14, two optical paths 15A,15B, a second coupler 16 and two output ports 17A,17B, as shown in the enlarged section of FIG. 2. One output port is connected to an input of the next interferometer 19 and the other is either not connected to anything or connected to a beam dump. An adjustment device 18 is provided in at least one of the optical paths 15A,15B, and preferably both, to adjust the optical length of that path. The adjustment device 18 may, for example, be a PIN diode formed across a rib waveguide as described in U.S. Pat. No. 5,757,986, or may be a thermal modulator, e.g. formed by a heater comprising a strip of aluminium deposited on a rib waveguide. By appropriate selection of the path lengths 15A, 15B in each interferometer, and/or operation of the adjustment devices 18 of each interferometer 19, a selected wavelength or wavelengths can be transmitted to a selected output port such that the individual wavelengths are finally transmitted to separate outputs of the demultiplexer 10.

Both PIN diodes and thermal modulators are easily fabricated, especially on silicon-on-insulator chips, and have low power consumption. Other forms of modulator which inject charge carriers into a waveguide may be used in place of a PIN diode.

However, the operation of such a demultiplexer is also temperature dependent. FIG. 3 shows a typical transfer function of a four-wavelength device. The graph shows four transfer functions, one for each of the output ports of the demultiplexer 10, the vertical axis being the transmission of the device and the horizontal axis the wavelength. Ideally, the wavelengths being separated should correspond to peaks of this function. As discussed above, this would conventionally be achieved by carefully controlling the temperature of the receiver 2 and the transmitter 1 by temperature stabilisation devices, eg by Peltier coolers, which have a relatively high power consumption. If the wavelengths received from the transmitter do not correspond to these peaks, the signal will be attenuated and significant problems with cross-talk between signals may arise.

As previously described, it is desired to be able to use simple inexpensive demultiplexers which tend to have a sinusoidal (or cosine squared) form of transfer function as shown in FIG. 3. This can be achieved if the operation of the interferometers is adjusted to follow the variations in the wavelengths of the signals received, eg by appropriate control of the adjustment devices 18.

As it is known that the wavelengths output from the transmitter 1 vary substantially in unison, as discussed above, it is sufficient to determine appropriate adjustments for one wavelength and apply the same adjustment to all wavelengths. However, in some arrangements, particularly when only a small number of channels are used, the appropriate adjustment for each wavelength may be determined individually.

Thus, if the output wavelengths all increase by, say, 1 nm due to an increase in the temperature of the transmitter, and adjustments are made to the demultiplexer to shift the whole transfer function along the wavelength axis by 1 nm, it will follow the variation in the output wavelengths and each wavelength should still fall substantially in the region of one of the peaks of the transfer function.

To achieve this, it is necessary to monitor one of the wavelengths to determine what adjustment should be made for all wavelengths. There are several ways this can be done:

1. A pilot tone may be added to a selected output signal and the wavelength response of the demultiplexer tuned to maximise the output of this tone.

2. A selected wavelength may be monitored before and after the demultiplexer and the demultiplexer tuned to maximise the ratio between these two signals.

3. The wavelength of a selected signal is measured at the input to the demultiplexer, eg by means of a wavelength locker, and the demultiplexer tuned according to a look up table.

4. A selected signal is averaged over a long enough period to remove dependency of the output on the data carried by the signal and the demultiplexer is tuned to maximise this signal.

The appropriate technique can be selected depending on the application and the requirements. For instance, in some cases, it may be known that there will always be a signal on the selected channel whereas in other cases it may not be certain that all channels will always be in use or whether a channel may sometimes carry a prolonged zero signal. In the latter cases, technique 1 above may need to be used.

Other demultiplexers that may be used include arrayed waveguide grating demultiplexers or grating-based devices, both of which are well-known. The wavelength response of these structures can be modified by the appropriate use of local thermal or carrier-injection techniques, as described for Mach-Zehnder structures.

The adjustment device 17 is preferably arranged with some dither so the adjustment oscillates across the peak of the curve with which it is desired to align the detected wavelength in order to make it easier to detect the position of the peak. Alternatively, the amplitude of the signal can be monitored with appropriate software.

The point to point link described above thus enables relatively simple, inexpensive apparatus to be used to provide a high data transfer. With the example given using four wavelengths, each could carry 2.5 Gbits of data so giving an overall transmission rate of 10 Gbits, or each channel could be 3.125 Gb/s giving an overall transmission rate of 12.5 Gb/s. A larger (or smaller) number of wavelengths may be used. There will, however, be practical constraints on how many can be used. Up to eight wavelengths may be feasible in some circumstances.

The system described above is also applicable to channels with other transmission rates, whether higher or lower than the examples given.

1. A point to point optical link comprising a transmitter, a receiver and an optical fibre for transmitting signals from the transmitter to the receiver, the transmitter comprising a plurality of light sources for providing signals of different wavelengths and combining means for combining the signals of different wavelengths onto a single channel for transmission along the optical fibre, and the receiver comprising a plurality of light sensors and demultiplexing means for separating the signals of different wavelengths and directing each wavelength to a respective light sensor, the output of the transmitter being temperature dependent and arranged so that the change in wavelength with respect to temperature for each of the signals of different wavelength is substantially similar, and the demultiplexing means being adjustable and arranged so that its response to signals with respect to their wavelength can be actively tuned so as to substantially follow variations in the wavelengths of the signals received.

2. A link as claimed in claim 1 in which the demultiplexing means comprises one or more Mach Zehnder interferometers.

3. A link as claimed in claim 1 in which the demultiplexing means comprises a grating, e.g. an arrayed waveguide grating.

4. A link as claimed in claim 2 or 3 in which the demultiplexing means comprises modulating means for adjusting its' response to signals with respect to their wavelength.

5. A link as claimed in claim 4 in which the modulating means comprises a PIN diode modulator or a thermal modulator.

6. A link as claimed in any preceding claim in which the transmitter and/or the receiver is fabricated on a silicon chip, e.g. a silicon-on-insulator chip.

7. A link as claimed in any preceding claim in which the light sources comprise distributed feedback lasers.

8. A link as claimed in claim 7 in which the lasers are InP lasers.

9. A link as claimed in any preceding claim in which the combining means comprises a cascade of Mach-Zehnder Interferometers.

10. A link as claimed in any preceding claim comprising a light source arranged to provide a pilot tone on a selected signal and sensing means for sensing the pilot signal, the arrangement being such that the wavelength response of the demultiplexer is tuned to maximise the output of the pilot tone.

11. A link as claimed in any preceding claim having sensing means for sensing a selected wavelength before and after the demultiplexer, the arrangement being such that the wavelength response of the demultiplexer is tuned to maximise the ratio between these signals.

12. A link as claimed in any preceding claim having sensing means to measure the wavelength of a selected signal received by the receiver, the arrangement being such that the wavelength response of the demultiplexer is tuned in accordance with stored data relating to the wavelength of the selected signal.

13. A link as claimed in any preceding claim having sensing means for determining the average magnitude of a selected signal over a period of time sufficient to remove variations due to data carried by the signal, the arrangement being such that the frequency response of the demultiplexer is tuned to maximise this signal.

14. A link as claimed in any preceding claim comprising four wavelength channels, each channel carrying 2.5 Gbits or 3.125 Gbits of data per second.
